(19) United States
(12) Patent Application Publication
(10) Pub. No.: US 2014/0006531 A1
(43) Pub. Date: Jan. 2, 2014

(54) MESSAGE DISTRIBUTION SYSTEM

(71) Applicant: Takahiro Sakiyama, Tokyo (JP)

(72) Inventor: Takahiro Sakiyama, Tokyo (JP)

(73) Assignee: KONAMI DIGITAL ENTERTAINMENT CO., LTD., Tokyo (JP)

(21) Appl. No.: 14/005,557

(22) PCT Filed: Feb. 1, 2012
(86) PCT No.: PCT/JP2012/052296

§ 371 Date: Sep. 17, 2013

(30) Foreign Application Priority Data
Mar. 18, 2011 (JP) 2011-061702

(51) Int. Cl. H04L 12/58

(52) U.S. Cl. CPC H04L 51/00
USPC 709/206

(57) ABSTRACT

To provide a message distribution system capable of keeping a message that offends a reader of the message from being distributed to many users. In a message distribution system, a message input by a user is distributed to one or a plurality of first distribution target users who are selected from among other users, and then distributed to one or a plurality of second distribution target users who are selected from among the other users. A feedback information obtaining unit obtains feedback created by the one or the plurality of first distribution target users on the message. A distribution-target-number control unit controls the number of users who are selected as the one or the plurality of second distribution target users based on the feedback information.

### TECHNICAL FIELD

The present invention relates to a message distribution system, a method of controlling a message distribution system, a message distribution control device, a program, and an information storage medium.

### BACKGROUND ART

There have been known message distribution systems which distribute a message input by a user to other users. Such message distribution systems enable a user to enjoy transmitting a message and reading messages that are input by other users.

### CITATION LIST

### Patent Literature

Patent Literature 1: JP 2002-301268 A

### SUMMARY OF INVENTION

### Technical Problem

In a message distribution system as those described above, the content of a message may offend a user who reads the message. Such a message needs to be kept from being distributed to many users. On the other hand, the content of a message may delight a reader of the message. Such a message is desired to be distributed to many users.

The present invention has been made in view of the problem described above, and an object of the present invention is therefore to provide a message distribution system, a method of controlling a message distribution system, a message distribution control device, a program, and an information storage medium that are capable of keeping a message, such as a message that offends a reader of the message, from being distributed to many users.

### Solution to Problem

In order to solve the above-mentioned problem, a message distribution system according to the present invention is a message distribution system for distributing a message that is input by a user to other users, the message distribution system including: message obtaining means for obtaining a message input by a user; first distribution means for distributing the message input by the user to one or a plurality of first distribution target users who are selected from among other users; feedback information obtaining means for obtaining feedback information about feedback created by the one or the plurality of first distribution target users on the message; second distribution means for, after the distribution is executed by the first distribution means, distributing the message to one or a plurality of second distribution target users who are selected from among the other users; and distribution-target-number control means for controlling a number of users who are selected as the one or the plurality of second distribution target users based on the feedback information.

Further, a method of controlling a message distribution system according to the present invention is a method of controlling a message distribution system for distributing a message that is input by a user to other users, the method including: a message obtaining step of obtaining a message input by a user; a first distribution step of distributing the message input by the user to one or a plurality of first distribution target users who are selected from among other users; a feedback information obtaining step of obtaining feedback information about feedback created by the one or the plurality of first distribution target users on the message; a second distribution step of, after the distribution is executed in the first distribution step, distributing the message to one or a plurality of second distribution target users who are selected from among the other users; and a distribution-target-number control step of controlling a number of users who are selected as the one or the plurality of second distribution target users based on the feedback information.

Further, a message distribution control device according to the present invention is a message distribution control device for distributing a message input by a user to one or a plurality of first distribution target users who are selected from among other users, and then distributing the message to one or a plurality of second distribution target users who are selected from among the other users, the message distribution control device including: feedback information obtaining means for obtaining feedback information about feedback created by the one or the plurality of first distribution target users on the message; and distribution-target-number control means for controlling a number of users who are selected as the one or the plurality of second distribution target users based on the feedback information.

Further, a program according to the present invention is a program for causing a computer to function as a message distribution control device for distributing a message input by a user to one or a plurality of first distribution target users who are selected from among other users, and then distributing the message to one or a plurality of second distribution target users who are selected from among the other users, the program causing the computer to function as: feedback information obtaining means for obtaining feedback information about feedback created by the one or the plurality of first distribution target users on the message; and distribution-target-number control means for controlling a number of users who are selected as the one or the plurality of second distribution target users based on the feedback information.

Further, a computer-readable information storage medium according to the present invention is a computer-readable information storage medium storing the above-mentioned program.

According to the present invention, for example, a message that offends a reader of the message can be kept from being distributed to many users.

Further, according to an aspect of the present invention, the second distribution means may, in each of a plurality of distribution periods, distribute the message to one or a plurality of second distribution target users who are selected from among the other users. The distribution-target-number control means may include means for controlling a number of the plurality of distribution periods based on the feedback information.

Further, according to an aspect of the present invention, the feedback information obtaining means may obtain first feedback information about the feedback created by the one or the plurality of first distribution target users on the message, and second feedback information about feedback created by the one or the plurality of second distribution target users on the message. The distribution-target-number control means may include means for controlling the number of the plurality of distribution periods based on the first feedback information and the second feedback information.

Further, according to an aspect of the present invention, the distribution-target-number control means may include means for controlling a number of users who are selected as the one or the plurality of second distribution target users based on the second feedback information, in second and subsequent distribution periods.

Further, according to an aspect of the present invention, the feedback information obtaining means may obtain first feedback information about the feedback created by the one or the plurality of first distribution target users on the message, and second feedback information about feedback created by the one or the plurality of second distribution target users on the message. The distribution-target-number control means may include: means for controlling a number of users who are selected as the one or the plurality of second distribution target users based on the first feedback information, in a first distribution period; and means for controlling a number of users who are selected as the one or the plurality of second distribution target users based on the second feedback information, in second and subsequent distribution periods.

Further, according to an aspect of the present invention, the second distribution means may distribute the message to the one or the plurality of second distribution target users who are selected from among the other users at a distribution time which repeatedly arrives in a distribution period. The distribution-target-number control means may control a length of the distribution period based on the feedback information.

Further, according to an aspect of the present invention, the message distribution system may further include means for displaying the message on display means, which is included in an information processing device corresponding to the one or each of the plurality of second distribution target users, and the message distribution system may further include at least one of: means for setting a display mode of the message displayed on the display means to a display mode corresponding to the number of users who are selected as the one or the plurality of second distribution target users; and means for displaying an image according to the number of users who are selected as the one or the plurality of second distribution target users on the display means in association with the message.

Further, according to an aspect of the present invention, the distribution-target-number control means may control the number of users who are selected as the one or the plurality of second distribution target users based further on classification information about a classification of contents of the message.

Further, according to an aspect of the present invention, the distribution-target-number control means may control the number of users who are selected as the one or the plurality of second distribution target users based further on size information about a size of the message.

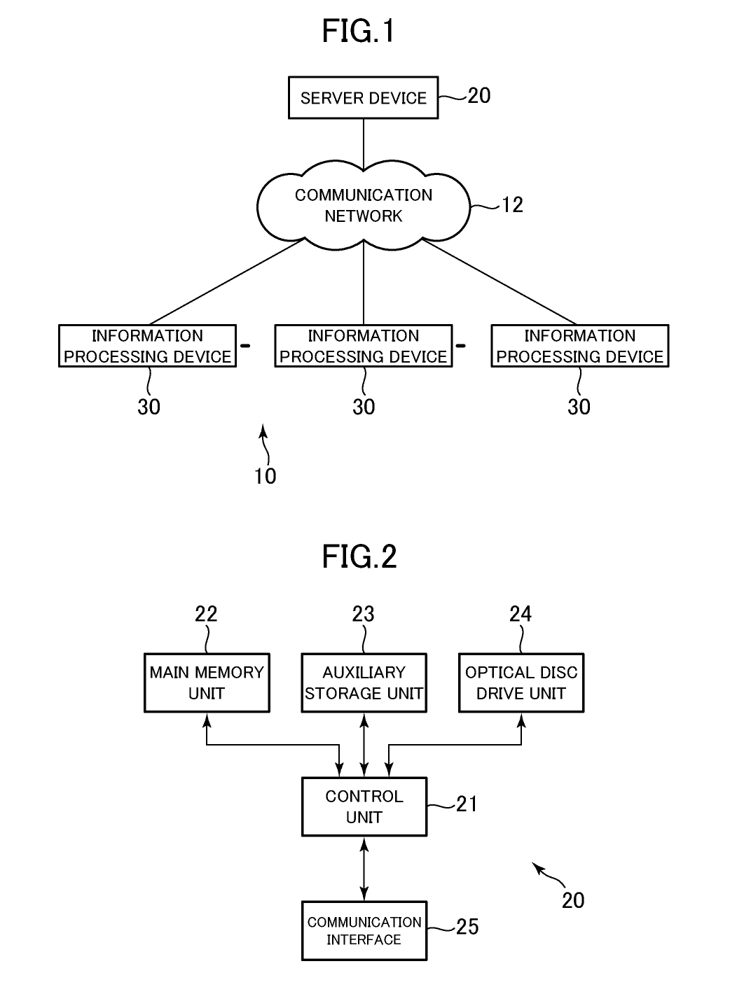

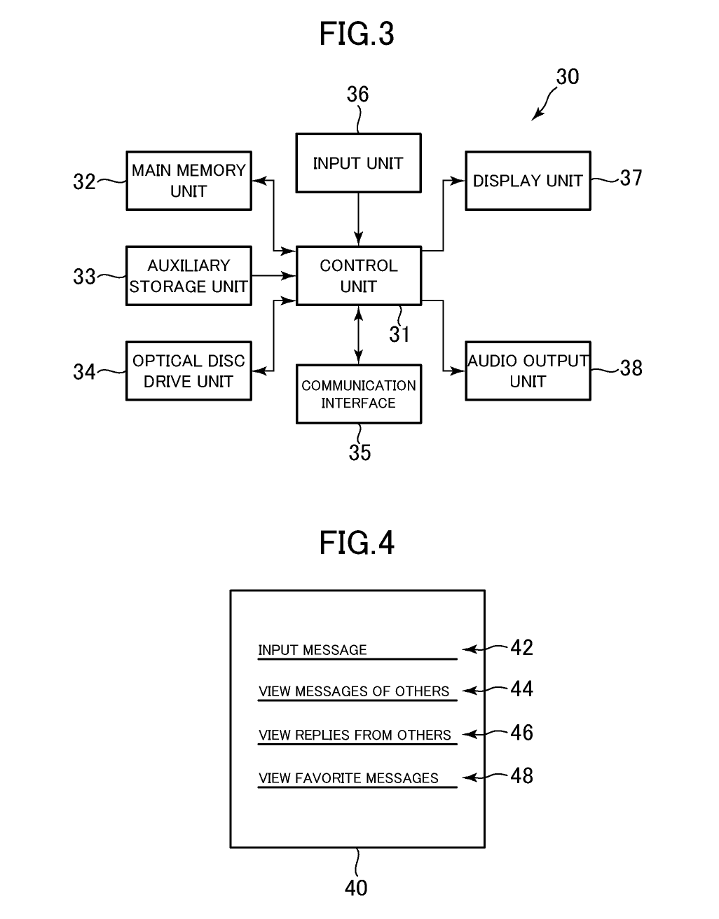

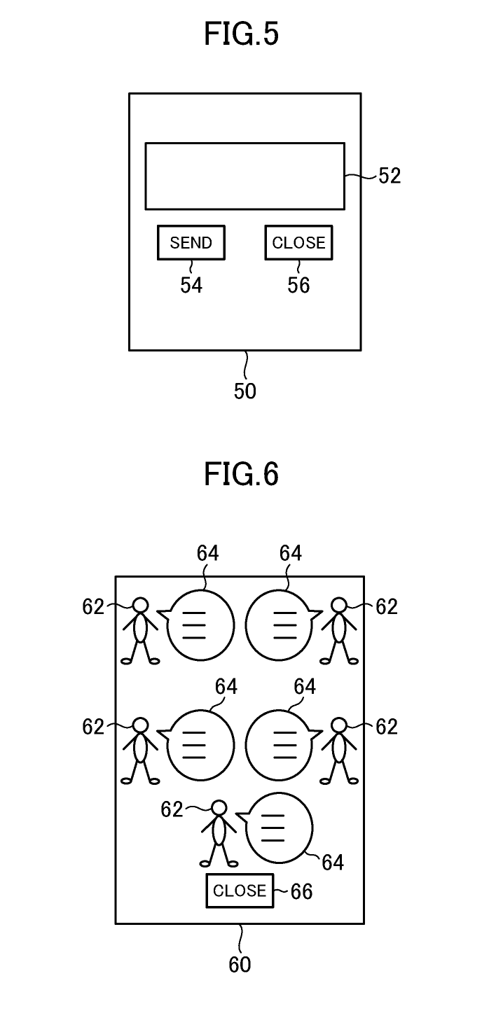

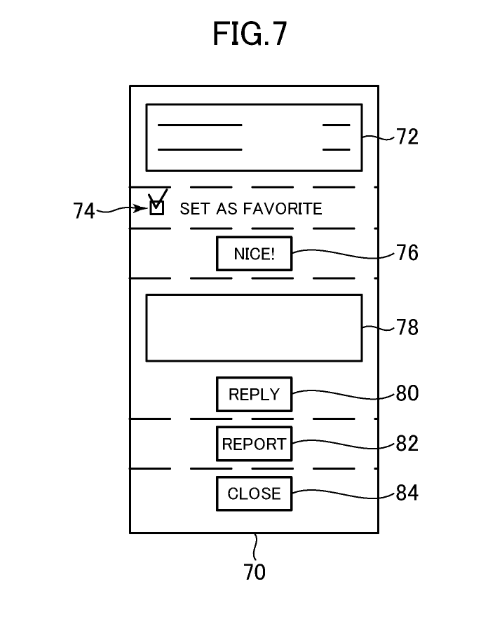

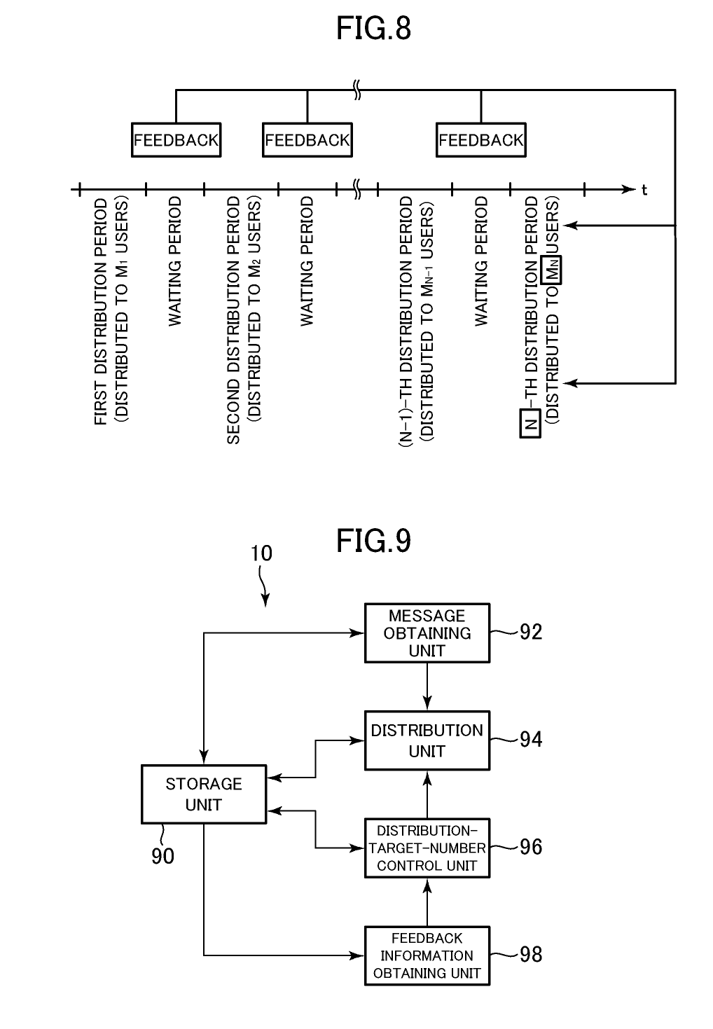

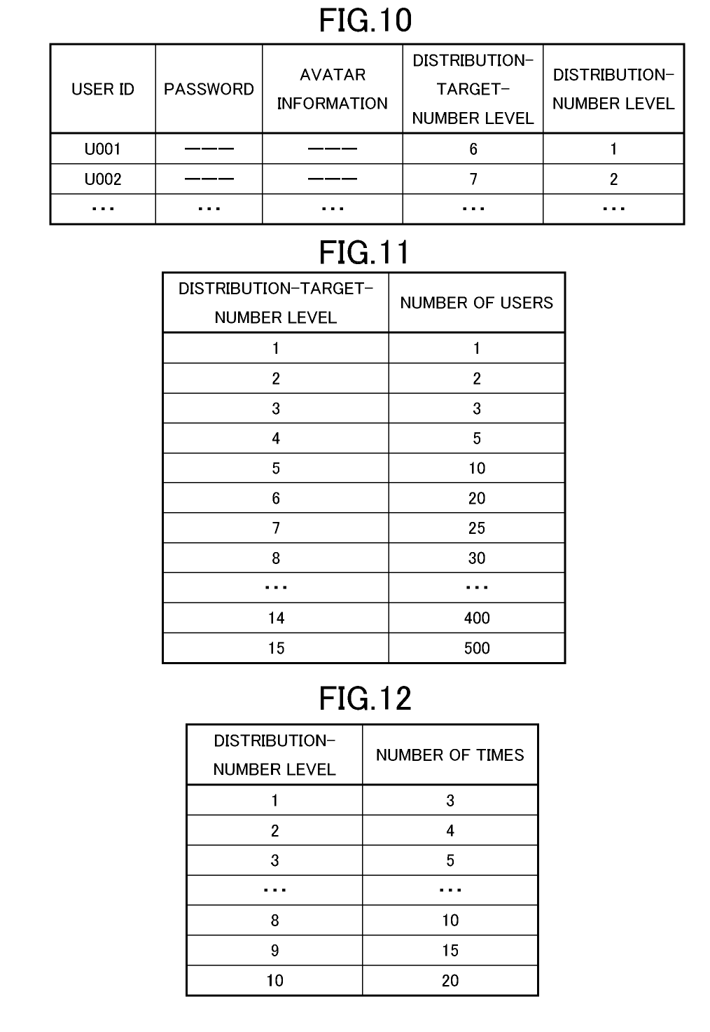

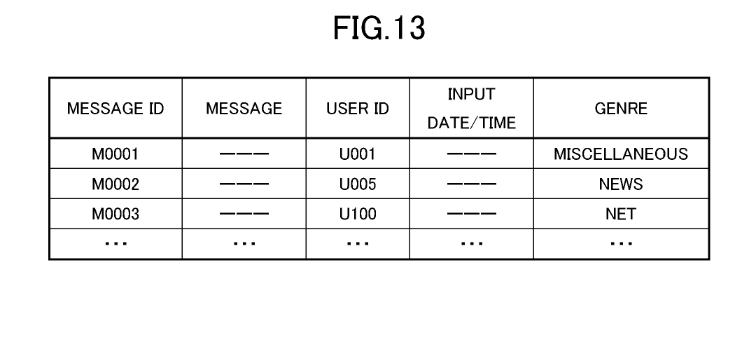

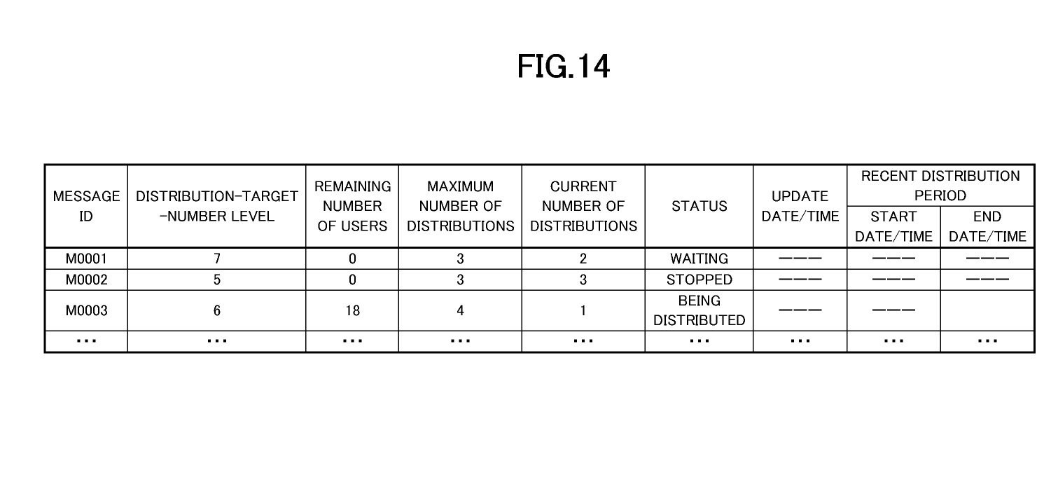

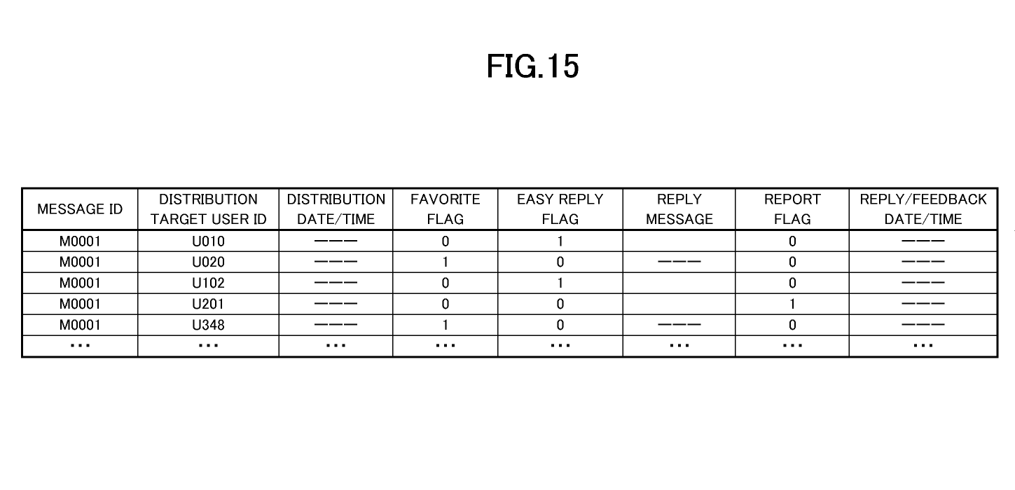

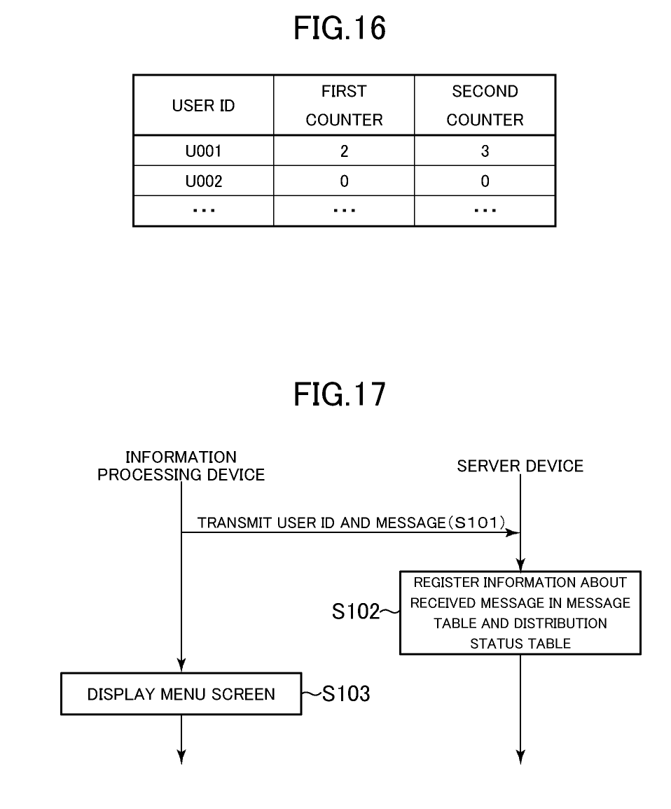

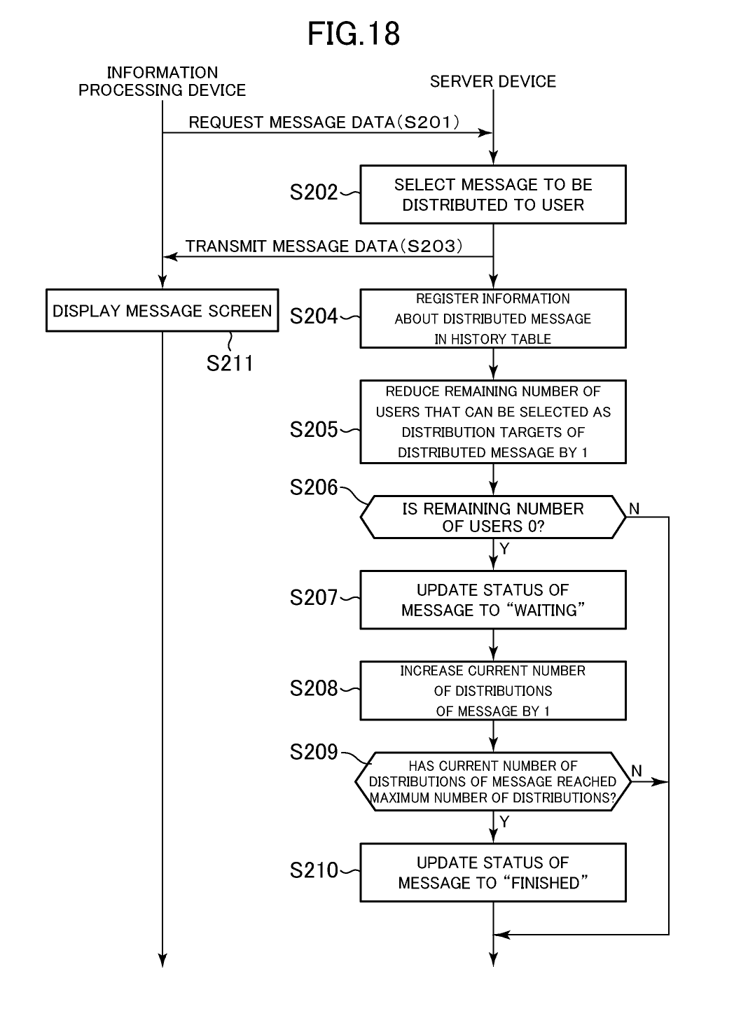

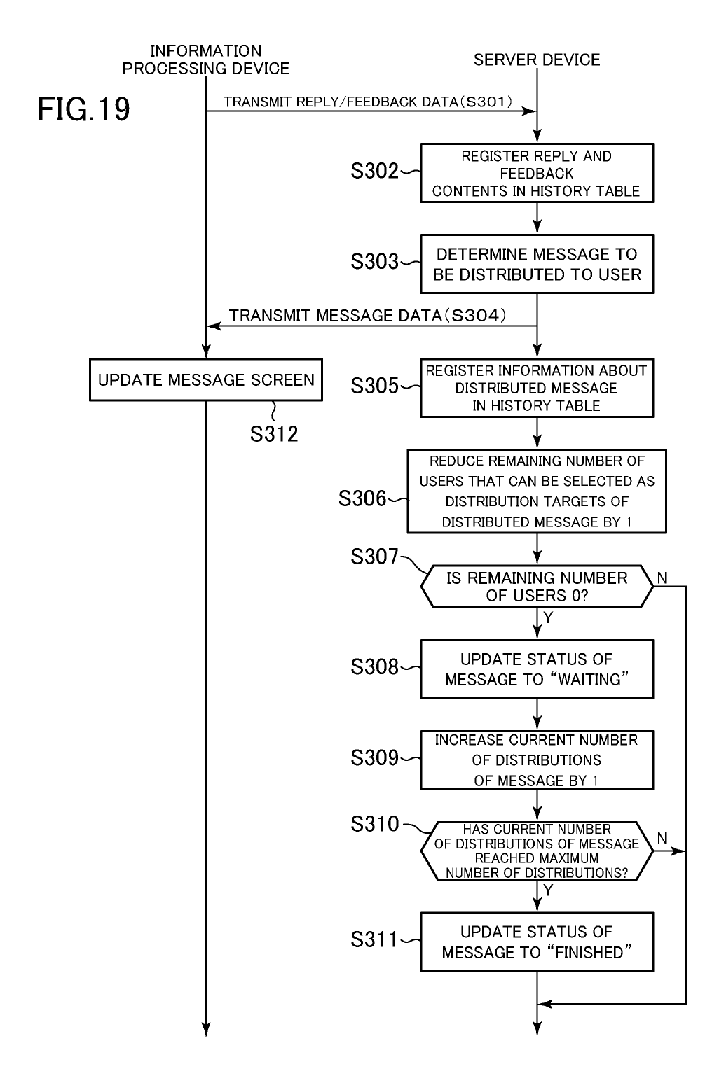

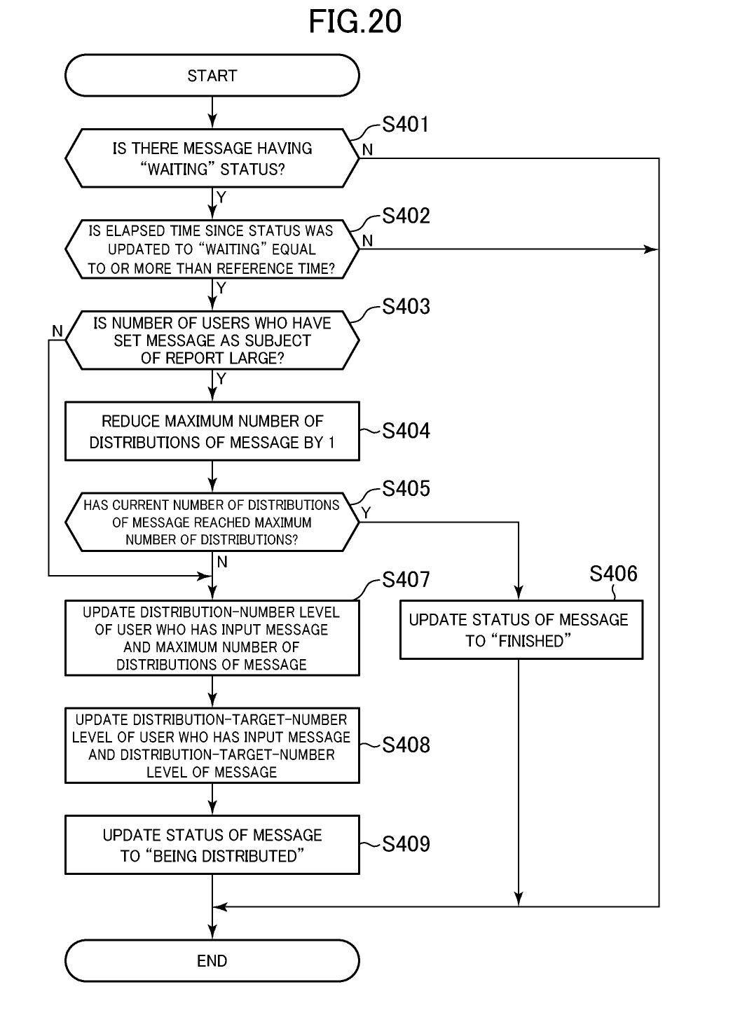

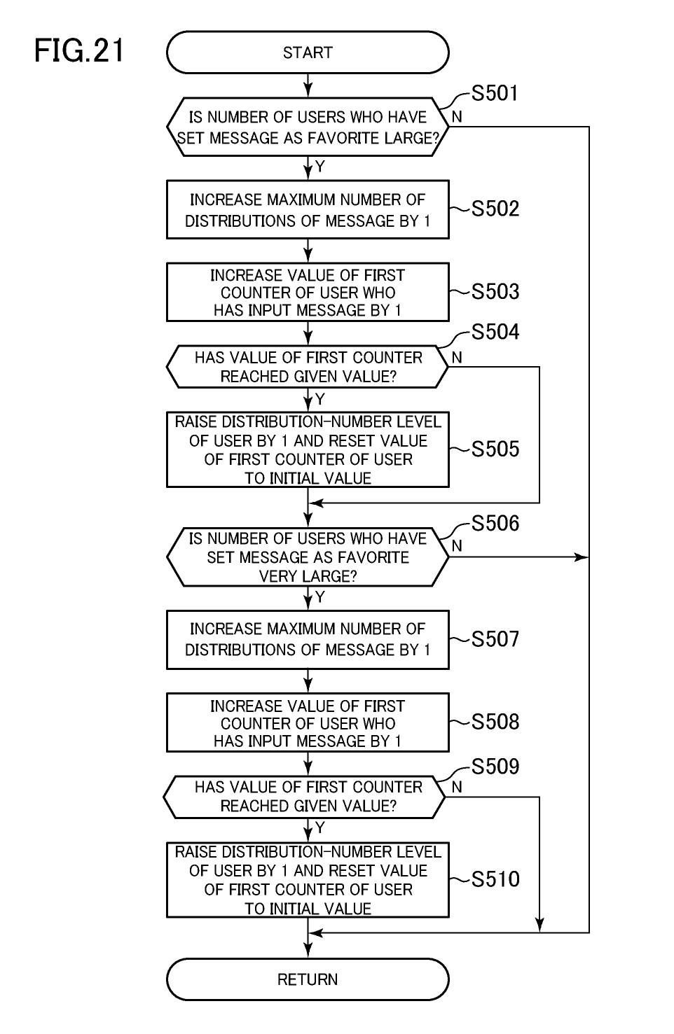

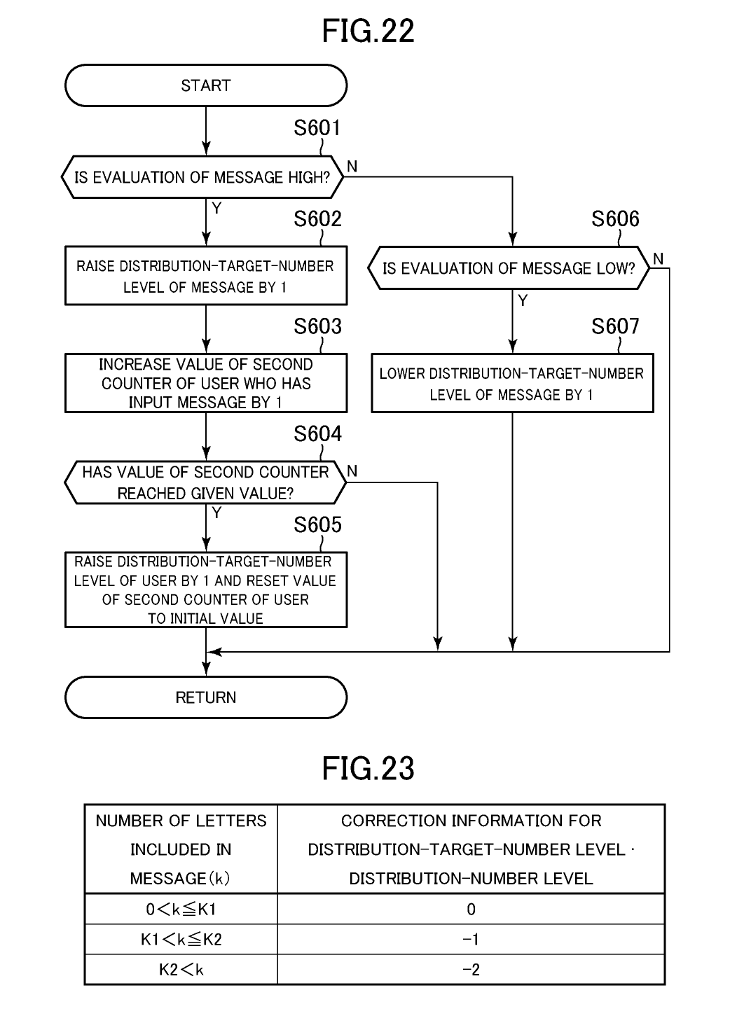

### BRIEF DESCRIPTION OF DRAWINGS

[FIG. 1] A diagram illustrating the overall configuration of a message distribution system according to an embodiment of the present invention.

[FIG. 2] A diagram illustrating the hardware configuration of a server device.

[FIG. 3] A diagram illustrating the hardware configuration of an information processing device.

[FIG. 4] A diagram illustrating an example of a menu screen.

[FIG. 5] A diagram illustrating an example of an input screen.

[FIG. 6] A diagram illustrating an example of a message screen.

[FIG. 7] A diagram illustrating an example of a reply screen.

[FIG. 8] A diagram for explaining a feature of the message distribution system.

[FIG. 9] A functional block diagram of the message distribution system.

[FIG. 10] A diagram illustrating an example of a user table.

[FIG. 11] A diagram illustrating an example of a distribution-target-number level table.

[FIG. 12] A diagram illustrating an example of a distribution-number level table.

[FIG. 13] A diagram illustrating an example of a message table.

[FIG. 14] A diagram illustrating an example of a distribution status table.

[FIG. 15] A diagram illustrating an example of a history table.

[FIG. 16] A diagram illustrating an example of a counter table.

[FIG. 17] A diagram illustrating an example of processing that is executed by the message distribution system.

[FIG. 18] A diagram illustrating an example of processing that is executed by the message distribution system.

[FIG. 19] A diagram illustrating an example of processing that is executed by the message distribution system.

[FIG. 20] A diagram illustrating an example of processing that is executed by the server device.

[FIG. 21] A diagram illustrating an example of processing that is executed by the server device.

[FIG. 22] A diagram illustrating an example of processing that is executed by the server device.

[FIG. 23] A diagram illustrating an example of a table that is stored in a storage unit.

### DESCRIPTION OF EMBODIMENT

An exemplary embodiment of the present invention is described in detail below with reference to the drawings.

FIG. 1 illustrates the overall configuration of a message distribution system according to an embodiment of the present invention. As illustrated in FIG. 1, the message distribution system 10 according to this embodiment includes a server device 20 (message distribution control device) and a plurality of information processing devices 30. The server device 20 and the plurality of information processing devices 30 are connected to a communication network 12, which includes, for example, a local area network (LAN) and/or the Internet. The server device 20 and an information processing device 30 can communicate data between each other.

The server device 20 is a device for executing control relevant to message distribution. The server device 20 is implemented by, for example, a server computer. FIG. 2 illustrates the hardware configuration of the server device 20. As illustrated in FIG. 2, the server device 20 includes a control unit 21, a main memory unit 22, an auxiliary storage unit 23, an optical disc drive unit 24, and a communication interface 25.

The control unit 21 includes, for example, a central processing unit (CPU) and executes information processing according to an operating system and other programs. The main memory unit 22 includes, for example, a random access memory (RAM). The auxiliary storage unit 23 includes, for example, a hard disk device. The optical disc drive unit 24 reads a program and data stored in an optical disc. The communication interface 25 is an interface for connecting the server device 20 to the communication network 12.

The information processing device 30 is an information processing device used by a user. The information processing device 30 is implemented by, for example, a cellular phone, a portable information terminal (a personal digital assistant: PDA), a personal computer, a portable game machine, or a consumer game machine (a stationary game machine). FIG. 3 illustrates the hardware configuration of the information processing device 30. As illustrated in FIG. 3, the information processing device 30 includes a control unit 31, a main memory unit 31, an auxiliary storage unit 33, an optical disc drive unit 34, a communication interface 35, an input unit 36, a display unit 37, and an audio output unit 38.

The control unit 31, the main memory unit 32, the auxiliary storage unit 33, the optical disc drive unit 34, and the communication interface 35 are similar to the control unit 21, main memory unit 22, auxiliary storage unit 23, optical disc drive unit 24, and communication interface 25 of the server device 20, respectively. The input unit 36 includes, for example, keys, a lever, a touch panel, a mouse, or a controller, and is used by a user to perform various operations or to give various instructions. The display unit 37 is, for example, a liquid crystal display panel and displays a screen according to an instruction from the control unit 31. The audio output unit 38 includes, for example, a speaker or headphones and outputs audio data according to an instruction from the control unit 31.

A program and data are provided to the server device 20 or the information processing device 30 via an optical disc. A program and data may be provided to the server device 20 or the information processing device 30 from a remote site via the communication network 12.

The message distribution system 10 configured as described above provides a service that enables a user to input a message and to view messages input by other users.

A user who wishes to use the service provided by the message distribution system 10 first performs user registration. Specifically, the user accesses the server device 20 from the information processing device 30 to register various kinds of information about himself/herself. The user who has performed user registration can use the service described above.

To use the service, the user accesses the server device 20 from the information processing device 30 and inputs a user ID and a password on a login screen (not shown). The input user ID and password are transmitted to the server device 20 in order to verify whether or not the combination of a user ID and a password is valid.

Instead of the user inputting a user ID and a password, the information processing device 30 may automatically transmit a terminal ID for uniquely identifying this information processing device 30 to the server device 20 so that login processing is executed based on the terminal ID. What is called “easy login” may be executed in this manner.

When it is determined that the combination of a user ID and a password is valid (or that the terminal ID is valid), a menu screen is displayed on the display unit 37 of the information processing device 30. FIG. 4 illustrates an example of the menu screen. Four links 42, 44, 46, and 48 are displayed in the menu screen 40 of FIG. 4.

The link 42 is a link to be selected when the user wishes to input a message. The link 44 is a link to be selected when the user wishes to view a message input by another user. The link 46 is a link to be selected when the user wishes to view a reply message from another user. The link 48 is a link to be selected when the user wishes to view a message that is set as a favorite.

When the user selects the link 42, an input screen for inputting a message is displayed on the display unit 37. FIG. 5 illustrates an example of the input screen. An input field 52, a send button 54, and a close button 54 are displayed on the input screen 50 of FIG. 5.

The input field 52 is a field provided for the user to input a message, and the message input by the user is displayed in the input field 52. The user inputs a message using the input unit 36, and after finishing inputting the message, selects the send button 54. When the send button 54 is selected, the message input by the user is transmitted to the server device 20 (see Step S101 of FIG. 17 which is described later). The close button 56 is a button for canceling the input of a message, and when the close button 56 is selected, the menu screen 40 is displayed.

When the user selects the link 44 on the menu screen, a message screen for viewing messages that are input by other users is displayed on the display unit 37. FIG. 6 illustrates an example of the message screen. Avatars 62, balloons 64, and a close button 66 are displayed the message screen 60 of FIG. 6.

An avatar 62 is a character corresponding to another user. A balloon 64 is displayed in association with the avatar 62. A message input by another user is displayed inside the balloon 64. Thus, on the message screen 60, it is made to look like the avatar 62 which is the representation of another user is telling a message that is input by the other user.

Although messages of five users are displayed on the message screen 60 of FIG. 6, messages of six or more users or messages of four or less users may be displayed.

In the message distribution system 10, the user can perform a reply to a message input by another user, or the like. Specifically, when the user selects one of the avatars 62 or one of the balloons 64, a reply screen for performing a reply to a message that is associated with the selected avatar 62 or balloon 64, or the like, is displayed on the display unit 37. FIG. 7 illustrates an example of the reply screen. A display field 72, a check box 74, an easy reply button 76, an input field 78, a reply button 80, a report button 82, and a close button 84 are the reply screen 70 of FIG. 7.

The message selected on the message screen 60 is displayed in the display field 72. The check box 74 is a box for selecting whether or not to set the message displayed in the display field 72 as a favorite. The user checks the check box 74 when wishing to set the message as a favorite. On the other hand, the user leaves the check box 74 unchecked when not wishing to set the message as a favorite. A message set as a favorite is displayed on a screen (not shown) that is displayed when the link 48 of the menu screen 40 is selected.

The easy reply button 76 is a button for providing a relatively simple way to reply to the message. A text “NICE!” is affixed to the easy replybutton 76, and when the easy replybutton 76 is selected, a message “Nice!” is used as a reply. The reply message created via the easy replybutton 76 is not limited to “Nice!” Another message indicating positive feedback such as “Like it!” or “Funny!” may be used instead of “Nice!” Alternatively, a message indicating negative feedback such as “Boring!” may be used.

The input field 78 is a field provided for the user to input a reply message, and a reply message input by the user is displayed in the input field 78. To send a reply message other than “Nice!” the user inputs a reply message using the input unit 36, and after finishing inputting the reply message, selects the reply button 80. When the reply button 80 is selected, the reply message input in the input field 78 is transmitted to the server device 20.

The report button 82 is a button for reporting to an administrator of the message distribution system 10 that the contents of a message are offensive. The user selects the report button 82 when the user is offended by reading the contents of a message. When the report button 82 is selected, the server device 20 is notified of the fact.

The close button 84 is a button for returning to the message screen 60 from the reply screen 70. The close button 66 on the message screen 60 (FIG. 6) is a button for returning to the menu screen 40 from the message screen 60.

When the user selects the link 46 on the menu screen 40 (FIG. 4), a screen (not shown) for viewing a reply message from another user is displayed on the display unit 37. When the user selects the link 48 on the menu screen 40 (FIG. 4), a screen (not shown) for viewing a message that has been set as a favorite by the user in the past is displayed on the display unit 37.

A description is given below of technology that is used in the message distribution system 10 described above to keep a message, for example, that offends a reader of the message, from being distributed to many people, and to purposely distribute a message that interests a reader of the message to many users.

FIG. 8 is a diagram for explaining a feature of the message distribution system 10. How the distribution of a message input by the user (referred to as “message X” for the sake of convenience) is carried out is described below with reference to FIG. 8.

The message distribution system 10 distributes the message X input by the user in a plurality of distribution periods (the first to N-th distribution periods). In the first distribution period, the message X is distributed to M₁ users. The symbol “M₁” represents a numerical value.

A waiting period is provided between the first distribution period and the second distribution period. The waiting period is a period for waiting for replies or the like to the message X from users who have received the message X in the first distribution period.

In the second distribution period, the message X is distributed to M₂ users. The symbol “M₂” represents a numerical value. A waiting period is provided between the second distribution period and the third distribution period as well. The waiting period is a period for waiting for replies or the like to the message X from users who have received the message X in the second distribution period.

The number of the distribution periods (N) of the message X is varied based on feedback on the message X from users who have received the message X in the first to (N−1)-th distribution periods.

The evaluation on the message X is determined by taking into account, for example, the number of replies to the message X, the number of users who have set the message X as a favorite, and the number of users who have set the message X as a subject of report. For instance, the evaluation on the message X becomes high when the number of replies to the message X and the number of users who have set the message X as a favorite are large, and the evaluation on the message X becomes low when the number of users who have set the message X as a subject of report is large.

When the evaluation of the message X is low, for example, the number of the distribution periods (N) is set to a lower number than when the evaluation on the message X is high.

In the N-th distribution period, the message X is distributed to M_{N} users. The symbol “M_{N}” represents a numerical value. The value of “M_{N}” is also varied based on feedback on the message X from users who have received the message X in the first to (N−1)-th distribution periods. For instance, when the evaluation on the message X is low, “M_{N}” is set to a value smaller than when the evaluation on the message X is high.

Though omitted from FIG. 8, the number of users to whom the message X is distributed in the second distribution period (M₂) is varied based on feedback on the message X from users who have received the message X in the first distribution period. Similarly, the number of users to whom the message X is distributed in the (N−1)-th distribution period (M_{N-1}) is varied based on feedback on the message X from users who have received the message X in the first to (N−2)-th distribution periods.

As described above, in the message distribution system 10, when the evaluation on the message X is low, the number of the distribution periods (N) of the message X and the number of users who are selected as distribution targets of the message X (M₂ to M_{N}) are set to relatively small numbers. For example, in the case where the contents of the message X offend others, the number of replies to the message X and the number of users who set the message X as a favorite are generally small and the number of users who set the message X as a subject of report is generally large. Consequently, the evaluation on the message X is low. Having the function described above, the message distribution system 10 prevents a message that offends others from being distributed to many users.

On the other hand, in the message distribution system 10, when the evaluation on the message X is high, the number of the distribution periods (N) of the message X and the number of users who are selected as distribution target of the message X (M₂ to M_{N}) are set to relatively large numbers. For example, in the case where the contents of the message X interest others, the number of replies to the message X and the number of users who set the message X as a favorite are generally large and the number of users who set the message X as a subject of report is generally small. Having the function described above, the message distribution system 10 purposely distributes a message that interests others to many users.

The following description is about a configuration for implementing the function described above. FIG. 9 is a functional block diagram illustrating functional blocks relevant to the function described above out of functional blocks implemented in the message distribution system 10. As illustrated in FIG. 9, the message distribution system 10 includes a storage unit 90, a message obtaining unit 92, a distribution unit 94, a distribution-target-number control unit 96, and a feedback information obtaining unit 98. Those functional blocks are implemented by, for example, the server device 20.

The storage unit 90 is described first. The storage unit 90 stores various types of data. FIGS. 10 to 16 each illustrate an example of data stored in the storage unit 90.

FIG. 10 illustrates an example of a user table. Information about users is registered in the user table. The user table of FIG. 10 includes a “user ID” field, a “password” field, an “avatar information” field, a “distribution-target-number level” field, and a “distribution-number level” field. Identification information for uniquely identifying a user is registered in the “user ID” field, and a password of the user is registered in the “password” field.

Information about the avatar 62 that is the representation of the user is registered in the “avatar information” field. For example, in the case where the user selects one of avatars prepared in advance as the avatar 62 of himself/herself, information that indicates the avatar 62 selected by the user is registered in the “avatar information” field. In the case where the user can generate the avatar 62 of himself/herself, information that indicates the avatar 62 generated by the user is registered in the “avatar information” field.

The distribution-target-number level of the user is registered in the “distribution-target-number level” field. The “distribution-target-number level” is information indicating the maximum number of users to whom a message input by the user is to be distributed in one distribution period. The association relation between the distribution-target-number level and a maximum number of distribution targets is defined in a distribution-target-number level table, which is illustrated in FIG. 11. The distribution-target-number level table of FIG. 11 is set so that the maximum number of distribution targets is higher when the distribution-target-number level is higher.

In the user table of FIG. 10, the distribution-target-number level of a user whose user ID is “U001” is “6”. In the distribution-target-number level table of FIG. 11, the number of users that are associated with the distribution-target-number level “6” is “20 users”. Therefore, a message input by the user whose user ID is “U001” is distributed to 20 users in the first distribution period, for example. In other words, “M₁” in FIG. 8 is set to 20.

The distribution-number level of the user is registered in the “distribution-number level” field of the user table. The “distribution-number” means the number of distribution periods (see FIG. 8), and the “distribution-number level” is information indicating the basic number of distribution periods of a message input by the user. The association relation between the distribution-number level and the basic number of distribution periods is defined in a distribution-number level table, which is illustrated in FIG. 12. The distribution-number level table of FIG. 12 is set so that the basic number of distribution periods is higher when the distribution-number level is higher.

In the user table of FIG. 10, the distribution-number level of the user whose user ID is “U001” is “1”. In the distribution-number level table of FIG. 12, the number of times that is associated with the distribution-number level “1” is “3”. Therefore, the initial number of distribution periods of a message input by the user whose user ID is “U001” is set to 3, for example. In other words, the initial value of “N” in FIG. 8 is set to 3. The number of distribution periods (N) of a message is increased or decreased based on a result of the evaluation on the message as described above.

For example, the initial value of the distribution-target-number level of a user is “6”, and the initial value of the distribution-number level of the user is “1”. The distribution-target-number level and distribution-number level of the user rise/fall based on the result of an evaluation on a message input by the user. For instance, the distribution-target-number level and distribution-number level of the user rise when the user repeatedly inputs a highly evaluated message, and fall when the user repeatedly inputs a lowly evaluated message. Details are described later (see Steps S505 and S510 of FIG. 21 and Step S605 of FIG. 22).

FIG. 13 illustrates an example of a message table. Information about messages input by users is registered in the message table. The message table of FIG. 13 includes a “message ID” field, a “message” field, a “user ID” field, an “input date/time” field, and a “genre” field.

Identification information for uniquely identifying a message is registered in the “message ID” field. The message itself is registered in the “message” field. The user ID of a user who has input the message is registered in the “user ID” field. The date/time at which the message was input is registered in the “input date/time” field. Information indicating the genre of the message is registered in the “genre” field.

FIG. 14 illustrates an example of a distribution status table. Information about a message distribution status is registered in the distribution status table. The distribution status table of FIG. 14 includes a “message ID” field, a “distribution-target-number level” field, a “remaining number of users” field, a “maximum number of distributions” field, a “current number of distributions” field, a “status” field, an “update date/time” field, and a “recent distribution period” field.

The distribution-target-number level of a message is registered in the “distribution-target-number level” field. When the message is input by a user, the distribution-target-number level of the user is registered in the “distribution-target-number level” field as the initial value of the distribution-target-number level of the message. The distribution-target-number level of a message rises/falls based on the result of an evaluation on the message (see Steps S602 and S607 of FIG. 22).

Information indicating how many people can still be selected as distribution targets of the message in the current distribution period is registered in the “remaining number of users” field. In other words, information indicating how many more users the message can be distributed to in the current distribution period is registered in the “remaining number of users” field. For example, at the beginning of a distribution period, the number of users corresponding to the distribution-target-number level of the message is registered in the “remaining number of users” field. For example, the value of the “remaining number of users” field decreases by 1, each time a distribution target of the message is selected (i. e., each time the message is distributed to a user who has been selected as a distribution target of the message) (see Step S205 of FIG. 18 and Step S306 of FIG. 19).

The maximum number of distribution periods of the message is registered in the “maximum number of distributions” field. For example, the initial value of the “maximum number of distributions” field is set to the number of times corresponding to the distribution-number level of the user who has input the message. The value of the “maximum number of distributions” field increases/decreases based on the result of an evaluation on the message (see Steps S502 and S507 of FIG. 21).

The number of distribution periods that have been implemented up to the present time is registered in the “current number of distributions” field. The value of the “current number of distributions” field increases by 1, for example, each time a distribution period ends (see Step S208 of FIG. 18 and Step S309 of FIG. 19).

The current status of the message is registered in the “status” field. One of values “being distributed”, “waiting”, and “finished” is registered in the “status” field. The value “being distributed” indicates that the present time is within a distribution period of the message. The value “waiting” indicates that the present time is within a waiting period. The value “finished” indicates that the distribution of the message has been finished.

The latest date/time at which the status has been updated is registered in the “update date/time” field. Information about the most recent distribution period is registered in the “recent distribution period” field. The “recent distribution period” field includes a “start date/time” field and an “end date/time” field. The start date/time and end date/time of the recent distribution period are registered in the “start date/time” field and the “end date/time” field. For instance, when the status of the message is “being distributed”, only the start date/time of the current distribution period is registered in the “start date/time” field. On the other hand, when the status of the message is “waiting” or “finished”, the start date/time and end date/time of the last distribution period are registered in the “start date/time” field and the “end date/time” field.

FIG. 15 illustrates an example of a history table. A distribution history of a message and a history of replies to/feedback on the message are registered in the history table. The history table of FIG. 15 includes a “message ID” field, a “distribution target user ID” field, a “distribution date/time” field, a “favorite flag” field, an “easy reply flag” field, a “reply message” field, a “report flag” field, and a “reply/feedback date/time” field.

The user ID of a user who is a distribution target of the message is registered in the “distribution target user ID” field. A date/time at which the message was distributed is registered in the “distribution date/time” field.

Information indicating whether or not the user who is a distribution target of the message has set the message as a favorite is registered in the “favorite flag” field. For example, one of values “0” and “1” is registered in the “favorite flag” field. The value “0” indicates that the message has not been set as a favorite, and the value “1” indicates that the message has been set as a favorite.

Information indicating whether or not the user who is a distribution target of the message has made an easy reply (i.e., whether or not the user has selected the easy reply button 76 on the reply screen 70) is registered in the “easy reply flag” field. For example, one of values “0” and “1” is registered in the “easy reply flag” field. The value “0” indicates that an easy reply has not been made, and the value “1” indicates that an easy reply has been made. A reply message input in the input field 78 on the reply screen 70 by the user who is a distribution target of the message is registered in the “reply message” field.

Information indicating whether or not the user who is a distribution target of the message has set the message as a subject of report (i.e., whether or not the user has selected the “report” button 82 on the reply screen 70) is registered in the “report flag” field. For example, one of values “0” and “1” is registered in the “report flag” field. The value “0” indicates that the message is not set as a subject of report and the value “1” indicates that the message is set as a subject of report. A date/time at which the user who is a distribution target of the message made a reply to/feedback on the message is registered in the “reply/feedback date/time” field.

FIG. 16 illustrates an example of a counter table. The counter table of FIG. 16 includes a “user ID” field, a “first counter” field, and a “second counter” field.

The value of a first counter of the user is registered in the “first counter” field. The “first counter” has a role of counting the number of times it is determined that a message input by the user is evaluated highly (see Steps S503 and S508 of FIG. 21). The value of the first counter is used to determine whether or not to raise the distribution-number level of the user. Specifically, the distribution-number level of the user is raised by 1 when the value of the first counter reaches a given value (see Steps S504, S505, S509, and S510 of FIG. 21).

The value of a second counter of the user is registered in the “second counter” field. The “second counter” also has a role of counting the number of times it is determined that a message input by the user is evaluated highly (see Step S603 of FIG. 22). However, the value of the second counter is used to determine whether or not to raise the distribution-target-number level of the user. Specifically, the distribution-target-number level of the user is raised by 1 when the value of the second counter reaches a given value (see Steps S604 and 605 of FIG. 22).

The message obtaining unit 92 is described next. The message obtaining unit 92 obtains a message input by a user. In this embodiment, a message input by a user on the input screen 50 is transmitted from the information processing device 30 to the server device 20, and the message obtaining unit 92 obtains the message transmitted from the information processing device 30.

The distribution unit 94, the distribution-target-number control unit 96, and the feedback information obtaining unit 98 are described next.

The distribution unit 94 distributes a message input by a user to other users. In this embodiment, the distribution unit 94 (first distribution means) distributes the message input by the user to one or a plurality of first distribution target users selected from other users. After the distribution to the first distribution target users is executed, the distribution unit (second distribution means) distributes the same message to one or a plurality of second distribution target users selected from the other users described above.

In the example described with reference to FIG. 8, distribution targets in the first distribution period, for example, correspond to the “first distribution target users”, and distribution targets in the second to N-th distribution periods correspond to the “second distribution target users”. When focusing on only the second distribution period and the third to N-th distribution periods, for example, it can be regarded that distribution targets in the second distribution period correspond to the “first distribution target users” while distribution targets in the third to N-th distribution periods correspond to the “second distribution target users”.

The feedback information obtaining unit 98 obtains feedback information about feedback from a user who has received a message on the message. The distribution-target-number control unit 96 controls the number of users who are selected as the second distribution target users based on feedback information obtained by the feedback information obtaining unit 98.

In this embodiment, in each of a plurality of distribution periods, the distribution unit 94 (second distribution means) distributes the message to one or a plurality of second distribution target users selected from the other users described above. In the example described with reference to FIG. 8, the number of the second to N-th distribution periods (N−1) corresponds to the “plurality of distribution periods”. The distribution-target-number control unit 96 controls the number of the distribution periods based on feedback information.

For instance, the feedback information obtaining unit 98 obtains first feedback information about feedback on a message from the first distribution target users. The distribution-target-number control unit 96 controls the number of users who are selected as the second distribution target users based on the first feedback information, also controls the number of the distribution periods described above based on the first feedback information.

The feedback information obtaining unit 98 may obtain second feedback information about feedback on a message from the second distribution target users as well. The distribution-target-number control unit 96 may control the number of the distribution periods described above based on the first feedback information and the second feedback information.

Specifically, the distribution-target-number control unit 96 may control, based on the first feedback information, the number of users who are selected as the second distribution target users in the first distribution period (the second distribution period in FIG. 8) out of the plurality of distribution periods described above (the second to N-th distribution periods in FIG. 8), and control, based on the second feedback information, the number of users who are selected as the second distribution target users in the second and subsequent distribution periods (the third to N-th distribution periods in FIG. 8) out of the plurality of distribution periods described above.

The description given next is about processing for implementing the functional blocks described above. FIGS. 17 to 22 are flow charts each illustrating an example of processing executed in the message distribution system 10.

Processing of FIG. 17 is described first. FIG. 17 is a flow chart illustrating an example of processing that is executed when a user inputs a message (namely, when a user selects the send button 54 on the input screen 50). For the sake of convenience, the following description of the processing of FIG. 17 assumes that a user A inputs a message.

When the user A selects the send button 54 of the input screen 50, the control unit 31 of the information processing device 30 transmits to the server device 20 the user ID of the user A who has input a message and the message input by the user A (S101). The control unit 21 (message obtaining unit 92) of the server device 20 receives the user ID and the message, and registers information about the message in the message table and the distribution status table (S102).

Specifically, the control unit 21 adds a new record to the message table. The control unit 21 also newly generates a message ID that does not match any existing message ID as the message ID of the received message. The control unit 21 registers the newly generated message ID in the “message ID” field of the newly added record. The control unit 21 further registers the received message and user ID in the “message” field and the “user ID” field, and registers the present date/time in the “input date/time” field.

The control unit 21 also determines the genre of the message based on the contents of the message, and registers the genre in the “genre” field. For example, the control unit 21 determines the genre of a message by determining whether or not the message contains a specific keyword. The user may specify the genre of the message on the input screen 50. In this case, information indicating the genre is also transmitted from the information processing device 30 to the server device 20 in Step S101.

The control unit 21 adds a new record to the distribution status table as well. The control unit 21 then registers the newly generated message ID described above in the “message ID” field of the newly added record. The control unit 21 also obtains from the user table the distribution-target-number level of the user who has input the message, and registers the obtained distribution-target-number level in the “distribution-target-number level” field. The control unit 21 further obtains from the distribution-target-number level table the number of users corresponding to the above-mentioned distribution-target-number level, and registers the obtained number of users in the “remaining number of users” field.

The control unit 21 also obtains from the user table the distribution-number level of the user A who has input the message. The control unit 21 further obtains from the distribution-number level table the number of times corresponding to the obtained distribution-number level, and registers the obtained number of times in the “maximum number of distributions” field. The control unit 21 registers 0 in the “current number of distributions” field. The control unit 21 further registers “being distributed” in the “status” field, and registers the present date/time in both of the “update date/time” field and the “start date/time” field of the “recent distribution period”.

Meanwhile, the control unit 31 of the information processing device 30 that has transmitted the user ID and the message displays the menu screen 40 on the display unit 37 (S103). This concludes the processing illustrated in FIG. 17.

Processing of FIG. 18 is described next. FIG. 18 is a flow chart illustrating an example of processing that is executed when a user performs an operation for displaying the message screen 60 (namely, when a user selects the link 44 on the menu screen 40). For the sake of convenience, the following description of the processing of FIG. 18 assumes that a user B selects the link 44 on the menu screen 40.

When the user B selects the link 44 on the menu screen 40, the control unit 31 of the information processing device 30 requests message data to the server device 20 (S201). In this case, the user ID of the user B is transmitted to the server device 20 along with this request.

The control unit 21 (distribution unit 94) of the server device 20 that receives the request described above selects a message to be distributed to the user B (S202). In this embodiment, where five messages are displayed on the message screen 60, the control unit 21 selects five messages.

Specifically, the control unit 21 selects five messages from among messages that satisfy all of the following conditions C1, C2, and C3.

(C1) A message is input by other users than the user B.

(C2) A message has never been distributed to the user B.

(C3) The status of a message is “being distributed”.

The control unit 21 determines whether or not a message satisfies the above-mentioned condition C1 based on the message table, determines whether or not a message satisfies the above-mentioned condition C2 based on the distribution status table and the history table, and determines whether or not a message satisfies the above-mentioned condition C3 based on the distribution status table.

The control unit 21 in this embodiment selects five messages to be distributed to the user B in a manner described below.

For instance, as a first message, the control unit 21 selects at random one of messages that satisfy all of the above-mentioned conditions C1 to C3 plus the following condition C4.

(C4) The distribution-target-number level of a message is equal to or higher than a reference level L1 (for example, 11).

As a second message, the control unit 21 selects at random one of messages that satisfy all of the above-mentioned conditions C1 to C3 plus the following condition C5.

(C5) The distribution-target-number level of a message is equal to or higher than a reference level L2 (for example, 6) and lower than the reference level L1.

As a third message, the control unit 21 selects at random one of messages that satisfy all of the above-mentioned conditions C1 to C3 plus the following condition C6.

(C6) The distribution-target-number level of a message is lower than the reference level L2.

The control unit 21 determines whether or not a message satisfies the above-mentioned condition C4, C5, or C6 based on the “distribution-target-number level” field of the message table.

As a fourth message, the control unit 21 selects at random one of messages that satisfy all of the above-mentioned conditions C1 to C3 plus the following condition C7.

(C7) A given time has elapsed since the last distribution date/time of a message.

The control unit 21 determines whether or not a message satisfies the above-mentioned condition C7 based on the “distribution date/time” field of the history table.

As a fifth message, the control unit 21 selects the latest message from among messages that satisfy the above-mentioned conditions C1 to C3. The control unit 21 executes this selection based on the “input date/time” field of the message table.

As a result of selecting the first to third messages in the manner described above, messages having different distribution-target-number levels are distributed to the user. As described above, the distribution-target-number level of a message is varied based on the distribution-target-number level of a user who has input the message and the result of an evaluation on the message. Consequently, messages input by users who have different distribution-target-number levels and messages having different evaluation results are distributed to the user.

As a result of selecting the fourth and fifth messages in the manner described above, messages that have been left undistributed for a while, and the latest messages, are distributed preferentially.

Selecting a message to be distributed to a user is equivalent to selecting the user as a distribution target of the message. Therefore, selecting in Step S202 five messages to be distributed to the user B can be rephrased as selecting the user B as a distribution target of those five messages.

After messages to be distributed to the user B are selected in Step S202, the control unit 21 transmits message data to the information processing device 30 of the user B (S203). The message data contains information about each message selected in Step S202. For example, the message data contains the message ID and contents of the message, and the user ID and avatar information of a user who has input the message.

The control unit 31 of the information processing device 30 that receives the message data displays the message screen 60 on the display unit 37 based on the message data (S211). For example, a message screen 60 such as the one illustrated in FIG. 6 is displayed on the display unit 37.

Meanwhile, the server device 20 that finishes transmitting the message data executes processing of Steps S204 to S210 which are described later. This processing is executed for each of the messages selected as messages to be distributed to the user B. For the sake of convenience, the following description of the processing of Steps S204 to S210 assumes that a message C input by the user A is selected as a message to be distributed to the user B.

The control unit 21 first registers information about the message C in the history table (S204). Specifically, the control unit 21 adds a new record to the history table. The control unit 21 registers the message ID of the message C in the “message ID” field of the newly added record. The control unit 21 further registers the user ID of the user B who is a distribution target of the message C in the “distribution target user ID” field, and registers the current date/time in the “distribution date/time” field.

Thereafter, the control unit 21 reduces the remaining number of users that can be selected as distribution targets of the message C in the current distribution period by 1 (S205), and determines whether or not the remaining number of users is 0 (S206). Specifically, the control unit 21 reduces the value of the “remaining number of users” field in a record of the distribution status table that is associated with the message C by 1, and determines whether or not the value is 0.

When it is determined that the remaining number of users is not 0, the control unit 21 ends this processing. On the other hand, when it is determined that the remaining number of users is 0, the control unit 21 updates the status of the message C to “waiting”, to thereby put the distribution of the message C on standby (S207). Specifically, the control unit 21 updates the value of the “status” field to “waiting” and updates the value of the “update date/time” field to the current date/time in a record of the distribution status table that is associated with the message C.

The control unit 21 further increases the current number of distributions of the message C by 1 (S208), and determines whether or not the current number of distributions of the message C has reached the maximum number of distributions of the message C (S209). Specifically, the control unit 21 increases the value of the “current number of distributions” field in a record of the distribution status table that is associated with the message C by 1, and determines whether or not the value of the “current number of distributions” field matches the value of the “maximum number of distributions” field.

The current number of distributions of the message C reaches the maximum number of distributions of the message C when the remaining number of distribution periods of the message C is 0. In this case, the control unit 21 updates the status of the message C to “finished”, thereby ending the distribution of the message C (S210). Specifically, the control unit 21 updates the value of the “status” field to “finished” and updates the value of the “update date/time” field to the current date/time in a record of the distribution status table that is associated with the message C. On the other hand, when the current number of distributions of the message C has not reached the maximum number of distributions of the message C, the control unit 21 ends this processing without executing Step S210. The processing of FIG. 18 is thus completed.

Processing of FIG. 19 is described next. FIG. 19 is a flow chart illustrating an example of processing that is executed when a user makes a reply to/feedback on a message that is input by another user (namely, when a user selects the easy reply button 76, the reply button 80, or the report button 82 on the reply screen 70). For the sake of convenience, the following description of the processing of FIG. 19 assumes that the user B drafts a reply to/feedback on the message C input by the user A.

When the user B selects the easy reply button 76, the reply button 80, or the report button 82 on the reply screen 70, the control unit 31 of the information processing device 30 transmits reply/feedback data to the server device 20 (S301). The reply/feedback data contains, for example, the following pieces of information.

(1) The user ID of the user B who has drafted the reply and feedback

(2) The message ID of the message C which is the subject of the reply and feedback

(3) Information indicating the contents of the reply to and feedback on the message C

The information indicating the contents of the reply to and feedback on the message C contains, for example, the following pieces of information.

(3-1) Information indicating whether or not the check box 74 has been checked (whether or not the message C has been set as a favorite)

(3-2) Information indicating which one of the easy reply button 76, the reply button 80, and the report button 82 has been selected

(3-3) Information indicating a reply message input in the input field 78

The control unit 21 (feedback information obtaining unit 98) of the server device 20 receives the reply/feedback data, and registers the contents of the reply to and feedback on the message C from the user B in the history table based on the reply/feedback data (S302).

The control unit 21 updates a record of the history table that corresponds to the combination of the message C and the user B. The “record that corresponds to the combination of the message C and the user B” is a record where the message ID of the message C is registered in the “message ID” field and the user ID of the user B is registered in the “distribution target user ID” field.

Specifically, the control unit 21 registers the current date/time in the “reply/feedback date/time” field. The control unit 21 also determines whether or not the user B has checked the check box 74 and registers “0” or “1” in the “favorite flag” field based on the result of the determination.

The control unit 21 further determines which one of the easy reply button 76, the reply button 80, and the report button 82 has been selected by the user B. The control unit 21 registers “1” in the “easy reply flag” field in the case where the user B has selected the easy reply button 76, and registers “0” in the “easy reply flag” field in the case where the user B has not selected the easy reply button 76.

In the case where the user B has selected the reply button 80, the control unit 21 registers in the “reply message” field a reply message that has been input in the message field 78. In the case where the user B has not selected the reply button 80, the control unit 21 leaves the “reply message” field blank. In the case where the user B has selected the report button 82, the control unit 21 registers “1” in the “report flag” field. The control unit 21 registers “0” in the “report flag” field in the case where the user B has not selected the report button 82.

After executing Step S302, the control unit 21 selects a message to be distributed to the user B (S303). Specifically, the control unit 21 selects a message to be newly displayed on the message screen 60 in place of the message C to which the user B has drafted a reply or feedback. For example, the control unit 21 selects at random one of messages that satisfy the conditions C1 to C3 described above. In this case, the control unit 21 selects the user B as a distribution target of one of messages that satisfy the conditions C1 to C3.

The control unit 21 then transmits message data to the information processing device 30 of the user B (S304). The message data contains information about the message selected in Step S303 as in Step S203 of FIG. 18.

The server device 20 that finishes transmitting the message data executes processing of Steps S305 to S311. This processing is executed for the message selected as a message to be distributed to the user B. The processing of Steps S305 to S311 is the same as the processing of Steps S204 to S210 in FIG. 18, and a description thereof is omitted.

Meanwhile, the control unit 31 of the information processing device 30 that receives the message data displays the message screen 60 on the display unit 37 based on the message data (S312). In this case, the information processing device 30 returns to the message screen 60 from the reply screen 70. This concludes the processing of FIG. 19.

Processing of FIG. 20 is described next. FIG. 20 is a flow chart illustrating an example of processing for resuming the distribution of a message the status of which is “waiting”. The processing of FIG. 20 is executed in the server device 20 at a given timing. For example, the server device 20 executes the processing of FIG. 20 every predetermined time (e.g., for every five minutes). Alternatively, the server device 20 executes the processing of FIG. 20 at a predetermined time.

As illustrated in FIG. 20, the control unit 21 first determines whether or not there is a message having a status “waiting” (S401). The control unit 21 executes this determination based on the “status” field in each record of the distribution status table. When it is determined that there is no message having the status “waiting”, the control unit 21 ends this processing.

On the other hand, when it is determined that there is a message having the status “waiting”, the control unit 21 executes processing for resuming the distribution of the message (Steps S402 to S409). As described later, processing executed in Steps S402 to S409 is for revising, prior to resuming the distribution of the message, the maximum number of distribution periods (“N” in FIG. 8) of the message and the maximum number of users who can be selected as distribution targets of the message in one distribution period (“M₂” to “M_{N}” in FIG. 8), based on results of replies to/feedback on the message.

When there is a plurality of messages having the status “waiting”, the control unit 21 executes the processing of Steps S402 to S409 separately for each of those messages. For the sake of convenience, the following description of the processing of Steps S402 to S409 assumes that the status of the message C input by the user A is determined as “waiting” in Step S401.

The control unit 21 first determines whether or not the time elapsed since the status of the message C was updated to “waiting” is equal to or more than a reference time (e.g., ten minutes) (S402). The control unit 21 calculates the elapsed time based on the “update date/time” field of the distribution status table. When it is determined that the elapsed time is less than the reference time, the control unit 21 ends this processing without executing Steps S403 to S409 for the message C.

On the other hand, when it is determined that the elapsed time is equal to or more than the reference time, the control unit 21 (feedback information obtaining unit 98) determines whether or not the number of users who have set the message C as a subject of report is large (S403).

For instance, the control unit 21 obtains the number of users who have issued a reply to/feedback on the message C within a target period (S). The “target period” is, for example, a period from the start time of the most recent distribution period to the current time. The control unit 21 obtains the above-mentioned number of users (S) by obtaining the number of records that satisfy the following conditions C8 and C9 from the history table.

(C8) The message ID of the message C is registered in the “message ID” field.

(C9) The date/time registered in the “reply/feedback date/time” field is within the target period.

The control unit 21 also obtains the number of users who have set the message C as a subject of report among the users who have made a reply/feedback within the target period (Sa). Specifically, the control unit 21 obtains the above-mentioned number of users (Sa) by obtaining the number of records that satisfy all of the above-mentioned conditions C8 and C9, plus the following condition C10, from the history table.

(C10) The value of the “report flag” field is “1”

The control unit 21 (feedback information obtaining unit 98) then calculates the proportion of users who have set the message C as a subject of report to the users who have issued a reply/feedback within the target period (Pa) by the following calculation formula F1.

Pa=Sa/S (F1)

After calculating the proportion Pa, the control unit 21 determines whether or not the proportion Pa is equal to or more than a reference value P1 (e.g., 0.05). When the proportion Pa is equal to or more than the reference value P1, the control unit 21 determines that the number of users who have set the message C as a subject of report is large.

The above-mentioned proportion Pa has a significance of being an evaluation value that indicates whether the evaluation on the message C is low or not. The evaluation on message C is low when the number of users who set the message C as a subject of report is large. Therefore, the evaluation on the message C is lower when the proportion Pc is higher. Determining whether the proportion Pa is high or not is equivalent to determining whether the evaluation on the message C is low or not.

When it is determined in Step S403 that the number of users who have set the message C as a subject of report is large, the control unit 21 (distribution-target-number control unit 96) reduces the maximum number of distributions of the message C by 1 (S404). Specifically, the control unit 21 reduces the value of the “maximum number of distributions” field by 1 in a record of the distribution status table that corresponds to the message C.

The control unit 21 further determines whether or not the current number of distributions of the message C has reached the maximum number of distributions of the message C (S405). In the case where the current number of distributions of the message C has reached the maximum number of distributions of the message C, the control unit 21 updates the status of the message C to “finished”, to thereby end the distribution of the message C (S406). Those steps are the same as the Steps S209 and S210 of FIG. 18.

On the other hand, when it is determined that the current number of distributions of the message C has not reached the maximum number of distributions of the message C, the control unit 21 executes Step S407. The control unit 21 also executes Step S407 when it is determined in Step S403 that the number of users who have set the message C as a subject of report is not large.

In Step S407, processing of updating the distribution-number level of the user who has input the message C and updating the maximum number of distributions of the message C is executed. FIG. 21 is a flow chart illustrating an example of this processing. For the sake of convenience, the following description of the processing of FIG. 21 assumes that the message C is a message input by the user A.

As illustrated in FIG. 21, the control unit 21 (feedback information obtaining unit 98) first determines whether or not the number of users who have set the message C as a favorite is large (S501).

For example, the control unit 21 obtains the number of users who have issued a reply to/feedback on the message C within a target period (S). The “target period” is, for example, a period from the start time of the most recent distribution period to the current time. The control unit 21 obtains the number of records that satisfy the above-mentioned conditions C8 and C9 from the history table (S).

The control unit 21 also obtains the number of users who have set the message C as a favorite among the users who have issued a reply/feedback within the target period (Sb). Specifically, the control unit 21 obtains the number of records that satisfy all of the above-mentioned conditions C8 and C9, plus the following condition C11, from the history table (Sb).

(C11) The value of the “favorite flag” field is “1”.

The control unit 21 (feedback information obtaining unit 98) then calculates the proportion (Pb) of users who have set the message C as a favorite to the users who have issued a reply/feedback within the target period using the following calculation formula F2.

Pb=Sb/S (F2)

After calculating the above-mentioned proportion Pb, the control unit 21 determines whether or not the proportion Pb is equal to or more than a reference value P2 (e.g., 0.05). When the proportion Pb is equal to or more than the reference value P2, the control unit 21 determines that the number of users who have set the message C as a favorite is large.

The proportion Pb has a significance of being an evaluation value that indicates whether the evaluation on the message C is high or not. The evaluation on the message C is high when the number of users who set the message C as a favorite is large. Therefore, the evaluation of the message C is higher when the proportion Pb is higher. Determining whether the proportion Pb is high or not is equivalent to determining whether the evaluation on the message C is high or not.

When it is determined that the number of users who have set the message C as a favorite is not large, the control unit 21 ends this processing. On the other hand, when it is determined that the number of users who have set the message C as a favorite is large, the control unit 21 (distribution-target-number control unit 96) increases the maximum number of distributions of the message C by 1 (S502). Specifically, the control unit 21 increases the value of the “maximum number of distributions” field by 1 in a record of the distribution status table that corresponds to the message C.

The control unit 21 also increases the value of the first counter of the user A who has input the message C by 1 (S503), and determines whether or not the value of the first counter of the user A has reached a given value (S504). Specifically, the control unit 21 increases the value of the “first counter” field by 1 in a record of the counter table that corresponds to the user A, and determines whether or not the value has reached the given value. When it is determined that the value of the first counter of the user A has not reached the given value, the control unit 21 executes Step S506, which is described later.

On the other hand, when it is determined that the value of the first counter of the user A has reached the given value, the control unit 21 raises the distribution-number level of the user A by 1 and resets the value of the first counter of the user A to the initial value (0) (S505). Specifically, the control unit 21 increases the value of the “distribution-number level” field in a record of the user table that corresponds to the user A by 1, and updates the value of the “first counter” field to the initial value (0) in a record of the counter table that corresponds to the user A.

After executing Steps S502 to S505, the control unit 21 (feedback information obtaining unit 98) determines whether or not the number of users who have set the message C as a favorite is very large (S506).

For example, the control unit 21 determines whether or not the above-mentioned proportion Pb calculated in Step S501 is equal to or more than a reference value P3 (e.g., 0.1). The reference value P3 is a value larger than the reference value P2 used in Step S501. When the proportion Pb is equal to or more than the reference value P3, the control unit 21 determines that the number of users who have set the message C as a favorite is very large.

When it is determined that the number of users who have set the message C as a favorite is not very large, the control unit 21 ends this processing. On the other hand, when it is determined that the number of users who have set the message C as a favorite is very large, the control unit 21 (distribution-target-number control unit 96) executes processing of further increasing the maximum number of distributions of the message C by 1 (S507) and processing of raising the distribution-number level of the user (S508 to S510). The processing of Steps S507 to S510 is the same as the processing of Steps S502 to S505, and a description thereof is omitted.

After executing Step S407 in FIG. 20 (namely, the processing of FIG. 21), the control unit 21 executes processing of updating the distribution-target-number level of the user who has input the message C and the distribution-target-number level of the message C (S408). FIG. 22 is a flow chart illustrating an example of this processing. For the sake of convenience, the following description of the processing of FIG. 22 also assumes that the message C is a message input by the user A.

As illustrated in FIG. 22, the control unit 21 (feedback information obtaining unit 98) first determines whether the evaluation on the message C is high or not (S601). For example, the control unit 21 determines whether the evaluation on the message C is high or not by determining whether or not results of replies/feedback made to/on the message C within a target period satisfy a given condition. The “target period” is, for example, a period from the start time of the most recent distribution period to the current time.

The control unit 21 in this embodiment calculates the evaluation value of the message C based on the results of replies/feedback made to/on the message C within the target period. The control unit 21 determines whether or not the evaluation value is contained within a given range of values, to thereby determine whether the evaluation on the message C is high or not.

Specifically, the control unit 21 calculates an evaluation value E of the message C using the following calculation formula F3 (“*” represents a multiplication operator).

E=(Sc*1+Sd*2+Sb*3−Sa*5)/S (F3)

In the calculation formula F3, “S” and “Sa” are the same as those in the calculation formula F1. Specifically, “S” represents the number of users who have issued a reply/feedback within the target period, and “Sa” represents the number of users who have set the message C as a subject of report out of the users who have issued a reply/feedback within the target period.

The symbol “Sb” is the same as the one in the calculation formula F2. Specifically, “Sb” represents the number of users who have set the message C as a favorite out of the users who have issued a reply/feedback within the target period.

The symbol “Sc” represents the number of users who have issued an easy reply to the message C out of the users who have issued a reply/feedback within the target period. The control unit 21 obtains the number of users (Sc) by obtaining the number of records that satisfy all of the above-mentioned conditions C8 and C9, plus the following condition C12, from the history table.

(C12) The value of the “easy reply flag” field is “1”.

The symbol “Sd” represents the number of users who have input a reply message to the message C out of the users who have issued a reply/feedback within the target period. The control unit 21 obtains the number of users (Sd) by obtaining the number of records that satisfy all of the above-mentioned conditions C8 and C9, plus the following condition C13, from the history table.

(C13) A reply message is registered in the “reply message” field (i.e., the “reply message” field is not blank).

In the calculation formula F3, the coefficients “1”, “2”, “3”, and “5” respectively represent weights associated with “Sc”, “Sd”, “Sb”, and “Sa”. Although the weight coefficients of “Sc”, “Sd”, “Sb”, and “Sa” are constants here, these weight coefficients may be variables.

For instance, the weight coefficient of “Sc”, which represents the number of users who have issued an easy reply to the message C, may be determined based on the result of a comparison between an easy reply ratio (Sc/S) of the message C and an average value of the easy reply ratios (Sc/S) of all messages within a given period (e.g., that day). For example, in the case where the easy reply ratio of the message C is higher than the average value described above, the weight coefficient of “Sc” may be set to a value larger than in the case where the easy reply ratio of the message C is not higher than the average value. The weight coefficients “Sd”, “Sb”, and “Sa” other than “Sc” may be determined by the same concept.

A case where the number of users who have issued an easy reply or a reply to the message C is larger or a case where the number of users who have set the message C as a favorite is large can be regarded as a case where the evaluation on the message C is high. A case where the number of users who have set the message C as a subject of report is large can be regarded as a case where the evaluation on the message C is low. The evaluation value E is larger when the number of users who have issued an easy reply or a reply to the message C is larger, or when the number of users who have set the message C as a favorite is larger. On the other hand, the evaluation value E is smaller when the number of users who have set the message C as a subject of report is larger. Accordingly, the evaluation value E is larger when the evaluation on the message C is higher and the evaluation value E is smaller when the evaluation on the message C is lower.

In the case where the topic of the message C is old, fewer users issue an easy reply or a reply to the message C. On the other hand, in the case where the topic of the message C is new, more users issue an easy reply or a reply to the message C, and the evaluation value E is consequently larger. Therefore, it can be said that the evaluation value E also indicates the freshness of the topic of the message C.

After calculating the above-mentioned evaluation value E, the control unit 21 determines whether or not the evaluation value E is larger than a reference value E1 (e.g., 0.5). When the evaluation value E is larger than the reference value E1, the control unit 21 determines that the evaluation on the message C is high.

When it is determined that the evaluation on the message C is high, the control unit 21 (distribution-target-number control unit 96) raises the distribution-target-number level of the message C by 1 (S602). Specifically, the control unit 21 increases the value of the “distribution-target-number level” field in a record of the distribution status table that corresponds to the message C by 1.

The control unit 21 also increases the value of the second counter of the user A who has input the message C by 1 (S603), and determines whether or not the value of the second counter of the user A has reached a given value (S604). Specifically, the control unit 21 increases the value of the “second counter” field in a record of the counter table that corresponds to the user A by 1, and determines whether or not the value has reached the given value.

When it is determined that the value of the second counter of the user A has not reached the given value, the control unit 21 ends this processing. On the other hand, when it is determined that the value of the second counter of the user A has reached the given value, the control unit 21 raises the distribution-target-number level of the user A by 1 and resets the value of the second counter to the initial value (0) (S605). Specifically, the control unit 21 increases the value of the “distribution-target-number level” field in a record of the user table that corresponds to the user A by 1, and updates the value of the “second counter” field to the initial value (0) in a record of the counter table that corresponds to the user A.

When it is determined in Step S601 that the evaluation on the message C is not high, the control unit 21 (feedback information obtaining unit 98) determines whether the evaluation on the message C is low or not (S606). Whether the evaluation on the message C is low or not is determined in the same way as in the determination on whether the evaluation on the message C is high or not (Step S601).

Specifically, the control unit 21 determines whether or not the above-mentioned evaluation value E is smaller than a reference value E2 (e.g., 0.2). The reference value E2 is a value smaller than the reference value E1 used in Step S601. When the evaluation value E is smaller than the reference value E2, the control unit 21 determines that the evaluation on the message C is low.

When it is determined that the evaluation on the message C is not low, the control unit 21 ends this processing. On the other hand, when it is determined that the evaluation on the message C is low, the control unit 21 (distribution-target-number control unit 96) lowers the distribution-target-number level of the message C by 1 (S607). Specifically, the control unit 21 reduces the value of the “distribution-target-number level” field in a record of the distribution status table that corresponds to the message C by 1. This concludes the processing of FIG. 22.

After executing Step S408 in FIG. 20 (namely, the processing of FIG. 22), the control unit 21 updates the status of the message C to “being distributed”, to thereby resume the distribution of the message C (S409).

Specifically, in a record of the distribution status table that corresponds to the message C, the control unit 21 updates the value of the “status” field to “being distributed” and updates the value of the “update date/time” field to the current date/time. Also, in the record that corresponds to the message C, the control unit 21 registers the current date/time in the “start date/time” field of the “recent distribution period” field and updates the “end date/time” field with a blank field. Further, in the record that corresponds to the message C, the control unit 21 updates the value of the “remaining number of users” field to the number of users that corresponds to a distribution-target-number level registered in the “distribution-target-number level” field.

In this case, a new distribution period of the message C starts, and the number of users that corresponds to the distribution-target-number level of the message C at this point is set as the maximum number of users who can be selected as distribution targets of the message C in this distribution period. For example, in the case where the evaluation on the message C is high, the distribution-target-number level of the message C is higher than the initial level (see Step S602 of FIG. 22), and the message C is therefore distributed to more users. On the other hand, in the case where the evaluation on the message C is low, the distribution-target-number level of the message C is lower than the initial level (see Step S607 of FIG. 22), and the number of users to whom the message C is distributed is kept low.

In the message distribution system 10 described above, the number of users who are subsequently selected as distribution targets of the message is controlled based on feedback on a message from users who have received the message. For example, when a message is evaluated lowly by users who have received the message, fewer users are subsequently selected as distribution targets of the message than when the message is evaluated highly. On the other hand, when a message is evaluated highly by users who have received the message, more users are subsequently selected as distribution targets of the message than when the message is evaluated lowly.

According to the message distribution system 10, for example, a message that offends a reader of the message can be kept from being distributed to a large number of users. Furthermore, for example, a message that pleases a reader of the message can be distributed to a large number of users.

As described above, it can be said that the evaluation value E (see the calculation formula F3) also indicates the freshness of the topic of a message. According to the message distribution system 10, in the case where the evaluation value E is small, the distribution-target-number level of a message is lowered from the initial level (see Step S607 of FIG. 22), and the number of users to whom the message is distributed is kept low. In other words, the message distribution system 10 makes it difficult for a message that deals with an old topic to be distributed. On the other hand, in the case where the evaluation value E is large, the distribution-target-number level of the message is increased from the initial level (see Step S602 of FIG. 22), and the message is distributed to more users. In other words, the message distribution system 10 distributes a message that deals with new topics more.

Consequently, the message distribution system 10 can prevent a message that deals with an old topic from continuing to be distributed indefinitely, and can distribute a message that deals with new topics more.

The present invention is not limited to the embodiment described above.

(1) Items that a user can input on the reply screen 70 are not limited to the example of FIG. 7. For instance, the reply screen 70 may be designed so that the user can specify registering another user who has input the message on a blacklist. To give another example, the reply screen 70 may be designed so that the user can input a numerical value indicating feedback on the message.

(2) The distribution status table (FIG. 14) may include a “remaining number of distributions” field which indicates the remaining number of distribution periods in place of the “maximum number of distributions” field and the “current number of distributions” field. In this case, processing of increasing the value of the “remaining number of distributions” field by 1 is executed instead of processing of increasing the value of the “maximum number of distributions” field by 1. Processing of reducing the value of the “remaining number of distributions” field by 1 is executed instead of processing of increasing the value of the “current number of distributions” field by 1.

(3) The distribution-target-number control unit 96 may control the number of users who are selected as the second distribution target users of a message based further on classification information about the classification of the contents of the message.

For instance, the storage unit 90 may store control information for controlling the number of users who are selected as the second distribution target users of a message in association with classification information about the classification of the contents of the message. Then, based on the control information associated with the classification of the contents of a message which has been obtained by the message obtaining unit 92, the distribution-target-number control unit 96 controls the number of users who are selected as the second distribution target users of the message.

A description is given of an example of concrete data and processing for implementing the function described above. In order to implement the function described above, for example, the storage unit 90 (user table) stores the distribution-target-number level and/or distribution-number level of a user for each genre. In this case, the genre corresponds to the above-mentioned “classification information” and the distribution-target-number level and/or the distribution-number level corresponds to the above-mentioned “control information”.

When information about the message is registered in the distribution status table in Step S102 of FIG. 17, the control unit 21 obtains the distribution-target-number level of the user A that is associated with the genre of the input message, and registers the obtained distribution-target-number level in the “distribution-target-number level” field. The control unit 21 also obtains from the distribution-target-number level table a number of users that is associated with the obtained distribution-target-number level, and registers the obtained number of user in the “remaining number of users” field.

The control unit 21 further obtains the distribution-number level of the user A that is associated with the genre of the input message. The control unit 21 obtains a number of times associated with the distribution-number level from the distribution-number level table, and registers the obtained count in the “maximum number of distributions” field.

The counter table stores the first counter and second counter of a user for each genre. When the value of the first counter of the user A who has input the message C is increased by 1 in Steps S503 and S508 in FIG. 21, the control unit 21 increases the value of the first counter of the user A that is associated with the genre of the message C by 1. When the value of the first counter of the user A that is associated with the genre of the message C reaches a given value, the control unit 21 raises the distribution-number level of the user A that is associated with the genre of the message C in Steps S505 and S510.

Similarly, when the value of the second counter of the user A who has input the message C is increased by 1 in Step S603 of FIG. 22, the control unit 21 increases the value of the second counter of user A that is associated with the genre of the message C. When the value of the second counter of the user A that is associated with the genre of the message C reaches a given value, the control unit 21 raises the distribution-target-number level of the user A that is associated with the genre of the message C in Step S605.

This way, when there is a user who inputs highly evaluated messages in a specific genre, for example, it can be arranged so that a message in the specific genre that is input by the user is distributed to more users compared to a message about another genre that is input by the user.

(4) The distribution-target-number control unit 96 may control the number of users who are selected as the second distribution target users of a message based further on size information which is about the size of the message.

For example, the storage unit 90 may store control information for controlling the number of users who are selected as the second distribution target users of a message in association with size information about the size of the message. Then, based on the control information that is associated with the size of a message which has been obtained by the message obtaining unit 92, the distribution-target-number control unit 96 controls the number of users who are selected as the second distribution target users of the message.

A description is given of an example of concrete data and processing for implementing the function described above. In order to implement the function described above, for example, the storage unit 90 stores a table illustrated in FIG. 23. The table of FIG. 23 is information that defines the association relation between a message size (a number of letters) and information for correcting the distribution-target-number level and/or the distribution-number level. Symbols “K1” and “K2” in FIG. 23 represent given numerical values.

In the table of FIG. 23, the information for correcting the distribution-target-number level and/or distribution-number level is information indicating how much the distribution-target-number level and/or the distribution-number level is to be lowered. The table of FIG. 23 is set so that the distribution-target-number level and/or the distribution-number level falls as the message size (the number of letters) increases.

When information about the message is registered in the distribution status table in Step S102 of FIG. 17, the control unit 21 obtains the distribution-target-number level of the user A who has input the message from the user table. The control unit 21 further obtains the size of the input message and obtains correction information that is associated with the obtained size. The control unit 21 registers, in the “distribution-target-number level” field, a distribution-target-number level that is obtained by changing the distribution-target-number level of the user A according to the correction information. The control unit 21 also obtains from the distribution-target-number level table a number of users that is associated with the distribution-target-number level obtained in the manner described above, and registers the obtained number of users in the “remaining number of users” field.

Similarly, the control unit 21 obtains the distribution-number level of the user A who has input the message from the user table. The control unit 21 obtains a distribution-number level that is obtained by changing the distribution-number level of user A according to the correction information. The control unit 21 obtains a number of times that is associated with the changed distribution-number level from the distribution-number level table, and registers the obtained number of times in the “maximum number of distributions” field.

This way, for example, the distribution-target-number level and/or the distribution-number level can be controlled so that the distribution-target-number level and/or the distribution-number level are lower when the message size increases. In other words, it can be arranged so that the number of users who are selected as distribution targets of a large-sized message is kept small compared to a small-sized message. As a result, the load on the communication network 12 is prevented from increasing, for example.

(5) The display mode of a message on the message screen 60 may be set to a display mode that is associated with the number of users who are selected as the second distribution target users of the message.

For example, the “display mode of the message” includes the display size, the text color, the background color, the font type or the like of the message, and the shape, size, color, or the like of the balloon 64.

The message distribution system 10 in this case varies the display mode of the message displayed on the message screen 60 based on information about the number of users who are selected as the second distribution target users of the message.

For example, the message distribution system 10 varies the display mode of the message displayed on the message screen 60 based on at least one of the following pieces of information a to e.

(a) The maximum number of distributions of the message

(b) The current number of distributions of the message

(c) The distribution-target-number level of the message

(d) The distribution-number level of a user who has input the message

(e) The distribution-target-number level of the user who has input the message

The pieces of information a to e all affect the number of users who are selected as distribution targets of the message. Therefore, each of the pieces of information a to e can correspond to the “information about the number of users who are selected as the second distribution target users” described above.

For example, when message data is transmitted to the information processing device 30 in Step S203 of FIG. 18 or Step S304 of FIG. 19, as part of the message data, the control unit 21 transmits control information for controlling the display mode of the message so that the display mode is varied based on at least one of the pieces of information a to e, to the information processing device 30. In Step S211 of FIG. 18 or Step S312 of FIG. 19, the control unit 31 sets the display mode of the message displayed on the message screen 60 based on the control information.

For example, information indicating the display mode of the message may be transmitted as the “control information” described above. Specifically, the control unit 21 determines the display mode of the message based on at least one of the pieces of information a to e, and transmits information that indicates the determined display mode (the control information) to the information processing device 30 as part of the message data.

In this case, the storage unit 90 needs to store data for determining the display mode of the message based on at least one of the pieces of information a to e. This data is, for example, data that associates at least one of the pieces of information a to e with information about a display mode of a message. The control unit 21 determines the message display mode based on this data.

To give another example, information that constitutes a basis for determining the display mode of the message may be transmitted as the “control information” described above. Specifically, the control unit 21 may obtain information that constitutes a basis for determining the display mode of the message based on at least one of the pieces of information a to e, and transmit the obtained information (control information) to the information processing device 30 as part of the message data. For example, the control unit 21 may transmit at least one of the pieces of information a to e itself (control information) to the information processing device 30 as part of the message data.

In this case, the control unit 31 sets the display mode of the message displayed on the message screen 60 based on the control information in Step S211 of FIG. 18 or Step S312 of FIG. 19. In this case, a storage unit (e.g., the auxiliary storage unit 33) of the information processing device 30 stores data for setting a display mode of a message based on the control information. The storage unit (e.g., the auxiliary storage unit 33) of the information processing device 30 stores, for example, data that associates the control information (e.g., at least one of the pieces of information a to e) with information about a display mode of a message. The control unit 31 sets the display mode of the message based on this data.

This way, a user can understand, from a display mode of a message displayed on the message screen 60, whether or not the message is distributed to a large number of users.

(6) An image according to the number of users who are selected as the second distribution target users of a message may be displayed on the message screen 60 in association with the message.

For example, the display mode of the image displayed in association with the message may be set to a displaymode corresponding to the number of users who are selected as the second distribution target users of the message. For example, the “image displayed in association with the message” is the avatar 62. However, the “image displayed in association with the message” can be other images than the avatar 62. The “display mode of the image” includes the display size, the color, the degree of translucency, the degree of feathering, the image type, or the like.

The message distribution system 10 in this case varies the display mode of the image displayed on the message screen 60 in association with the message based on information about the number of users who are selected as the second distribution target users of the message.

A concrete configuration for varying the display mode of the image displayed on the message screen 60 in association with the message can be the same as the configuration for varying the display mode of the message in the modification example (5) described above.

(7) The description given above deals with distributing a message over a plurality of distribution periods (FIG. 8). Alternatively, a message may be distributed in one distribution period.

The control unit 21 in this case obtains evaluation information about evaluation on the message at a determination time, which is set repeatedly within the distribution period, to extend and/or cut short the distribution period of the message based on the evaluation on the message. For example, the control unit 21 may extend the distribution period of the message when the evaluation on the message is high, and cut short the distribution period of the message when the evaluation on the message is low.

The “determination time” may be set at given time intervals. Alternatively, a time when the remaining time till the end of the distribution period becomes equal to or less than a given time may be set as the “determination time”.

In this manner, the number of users who are selected as distribution target users of a message increases/decreases as a result of extending or cutting short the distribution period of the message. In other words, when configured as above, for example, a message that offends a reader of the message can be kept from being distributed to a large number of users. Further, for example, a message that pleases a reader of the message can be distributed to a large number of users.

The invention claimed is:

1. A message distribution system for distributing a message that is input by a user to other users, comprising:
message obtaining means for obtaining a message input by a user;
first distribution means for distributing the message input by the user to one or a plurality of first distribution target users who are selected from among other users;
feedback information obtaining means for obtaining feedback information about feedback created by the one or the plurality of first distribution target users on the message;
second distribution means for, after the distribution is executed by the first distribution means, distributing the message to one or a plurality of second distribution target users who are selected from among the other users; and
distribution-target-number control means for controlling a number of users who are selected as the one or the plurality of second distribution target users based on the feedback information.

2. The message distribution system according to claim 1,
wherein the second distribution means, in each of a plurality of distribution periods, distributes the message to one or a plurality of second distribution target users who are selected from among the other users, and
wherein the distribution-target-number control means comprises means for controlling a number of the plurality of distribution periods based on the feedback information.

3. The message distribution system according to claim 2,
wherein the feedback information obtaining means obtains first feedback information about the feedback created by the one or the plurality of first distribution target users on the message, and second feedback information about feedback created by the one or the plurality of second distribution target users on the message, and
wherein the distribution-target-number control means comprises means for controlling the number of the plurality of distribution periods based on the first feedback information and the second feedback information.

4. The message distribution system according to claim 3, wherein the distribution-target-number control means comprises means for controlling a number of users who are selected as the one or the plurality of second distribution target users based on the second feedback information, in second and subsequent distribution periods.

5. The message distribution system according to claim 2,
wherein the feedback information obtaining means obtains first feedback information about the feedback created by the one or the plurality of first distribution target users on the message, and second feedback information about feedback created by the one or the plurality of second distribution target users on the message, and
wherein the distribution-target-number control means comprises:
means for controlling a number of users who are selected as the one or the plurality of second distribution target users based on the first feedback information, in a first distribution period; and
means for controlling a number of users who are selected as the one or the plurality of second distribution target users based on the second feedback information, in second and subsequent distribution periods.

6. The message distribution system according to claim 1,
wherein the second distribution means distributes the message to the one or the plurality of second distribution target users who are selected from among the other users at a distribution time which repeatedly arrives in a distribution period, and
wherein the distribution-target-number control means controls a length of the distribution period based on the feedback information.

7. The message distribution system according to claim 1, further comprising means for displaying the message on display means, which is included in an information processing device corresponding to the one or each of the plurality of second distribution target users,
wherein the message distribution system comprises at least one of:
means for setting a display mode of the message displayed on the display means to a display mode corresponding to the number of users who are selected as the one or the plurality of second distribution target users; and
means for displaying an image according to the number of users who are selected as the one or the plurality of second distribution target users on the display means in association with the message.

8. The message distribution system according to claim 1, wherein the distribution-target-number control means controls the number of users who are selected as the one or the plurality of second distribution target users based further on classification information about a classification of contents of the message.

9. The message distribution system according to claim 1, wherein the distribution-target-number control means controls the number of users who are selected as the one or the plurality of second distribution target users based further on size information about a size of the message.

10. A method of controlling a message distribution system for distributing a message that is input by a user to other users, the method comprising:
a message obtaining step of obtaining a message input by a user;
a first distribution step of distributing the message input by the user to one or a plurality of first distribution target users who are selected from among other users;
a feedback information obtaining step of obtaining feedback information about feedback created by the one or the plurality of first distribution target users on the message;
a second distribution step of, after the distribution is executed in the first distribution step, distributing the message to one or a plurality of second distribution target users who are selected from among the other users; and
a distribution-target-number control step of controlling a number of users who are selected as the one or the plurality of second distribution target users based on the feedback information.

11. A message distribution control device for distributing a message input by a user to one or a plurality of first distribution target users who are selected from among other users, and then distributing the message to one or a plurality of second distribution target users who are selected from among the other users, the message distribution control device comprising:
feedback information obtaining means for obtaining feedback information about feedback created by the one or the plurality of first distribution target users on the message; and
distribution-target-number control means for controlling a number of users who are selected as the one or the plurality of second distribution target users based on the feedback information.

12. A non-transitory computer-readable information storage medium storing a program for causing a computer to function as a message distribution control device for distributing a message input by a user to one or a plurality of first distribution target users who are selected from among other users, and then distributing the message to one or a plurality of second distribution target users who are selected from among the other users,
the program causing the computer to function as:
feedback information obtaining means for obtaining feedback information about feedback created by the one or the plurality of first distribution target users on the message; and
distribution-target-number control means for controlling a number of users who are selected as the one or the plurality of second distribution target users based on the feedback information.

13. (canceled)
